(19) United States
(12) Patent Application Publication
(10) Pub. No.: US 2003/0016294 A1
(43) Pub. Date: Jan. 23, 2003

(54) Compensation apparatus for digital image signal

(76) Inventor: Sean Chiu, Taipei (TW)

Correspondence Address: RABIN & CHAMPAGNE, PC, 1101 14TH STREET, NW, SUITE 500, WASHINGTON, DC, 20005, US

(21) Appl. No.: 09/905,959

(22) Filed: Jul. 17, 2001

(51) Int. Cl. H04N 5/225; H04N 5/217

(52) U.S. Cl. 348/241

(57) ABSTRACT

A compensation apparatus for digital image signal comprises an AFE (analog front end), a timing circuit, a differential pulse coding modulation (DPCM) unit and an arithmetic unit. The AFE digitalizes an analog signal from an image capture apparatus. The timing circuit provides timing control for the compensation apparatus. The DPCM unit for obtains offset and gain compensation parameter for each pixel. The arithmetic unit performs arithmetic operation to the digital signal of the AFE with respect to the offset and gain compensation parameter of the DPCM unit, thus obtaining compensated pixel.

### FIELD OF THE INVENTION

The present invention relates to a compensation apparatus for digital image signal, especially to a compensation apparatus using differential pulse coding modulation (DPCM) for compensating digital image signal.

### BACKGROUND OF THE INVENTION

The prior art image capture apparatus such as scanner, digital still camera (DSC) and digital video camera generally use charge coupled device or CMOS sensor for obtaining image data. However, the image capture apparatus may have image deviation due to discrepancy in optical and physical property of each pixel thereof, the image capture apparatus requires a compensation scheme to eliminate the image deviation. Moreover, the image capture apparatus may have pike noise due to dirt on surface or instable power supply, as shown in FIG. 1A. Even though in absence of luminance, the image capture apparatus also has pike noise due to dark current, as shown in FIG. 1B.

The conventional compensation scheme for image capture apparatus can be classified into dark shading method (without luminance) and white shading method (with luminance). In each method, the output signal of the image capture apparatus is subjected to a gain compensation operation or an offset compensation operation. The output signal of the image capture apparatus may have different compensation parameters for each pixel thereof. The storing of compensation parameters requires large storage space. Moreover, the pike noise occurred in certain pixel requires more bit for precise representation, which worsens the problem.

The storage space for gain and offset compensation parameters can be reduced at the expense of degraded resolution. The picture quality is deteriorated. Alternatively, the gain and offset compensation operations can be resorted to more powerful platform such as PC for scanner. However, this approach is not applicable to PDA (personal digital assistant).

### SUMMARY OF THE INVENTION

It is the object of the present invention to provide a compensation apparatus with less storage space and faster accessing speed.

In one aspect of the invention, the offset data for each pixel is encoded and packeted beforehand in a host platform or offline and then stored in the compensation apparatus.

In another aspect of the invention, differential pulse coding modulation (DPCM) is used to reduce storage space.

To achieve above object, the present invention provides a compensation apparatus for digital image signal comprising an AFE (analog front end), a timing circuit, an offset DPCM unit and a subtractor for offset compensation.

Alternative, the compensation apparatus for digital image signal comprising an AFE (analog front end), a timing circuit, a DPCM gain unit and a multiplier for gain compensation.

Alternative, the compensation apparatus for digital image signal comprising an AFE (analog front end), a timing circuit, a DPCM gain unit, a multiplier a DPCM gain unit and a multiplier for offset and gain compensation.

The various objects and advantages of the present invention will be more readily understood from the following detailed description when read in conjunction with the appended drawing, in which:

### BRIEF DESCRIPTION OF DRAWINGS

FIG. 1A shows the pike noise distribution in dark shading calibration;

FIG. 1B shows the pike noise distribution in white shading calibration;

FIG. 2 shows the schematic diagram of the first preferred embodiment of the present invention;

FIG. 3 is a flowchart for the first preferred embodiment of the present invention;

FIG. 4 shows the schematic diagram of the second preferred embodiment of the present invention;

FIG. 5 shows part of the schematic diagram of the third preferred embodiment of the present invention; and

FIG. 5A shows part of the schematic diagram of the third preferred embodiment of the present invention.

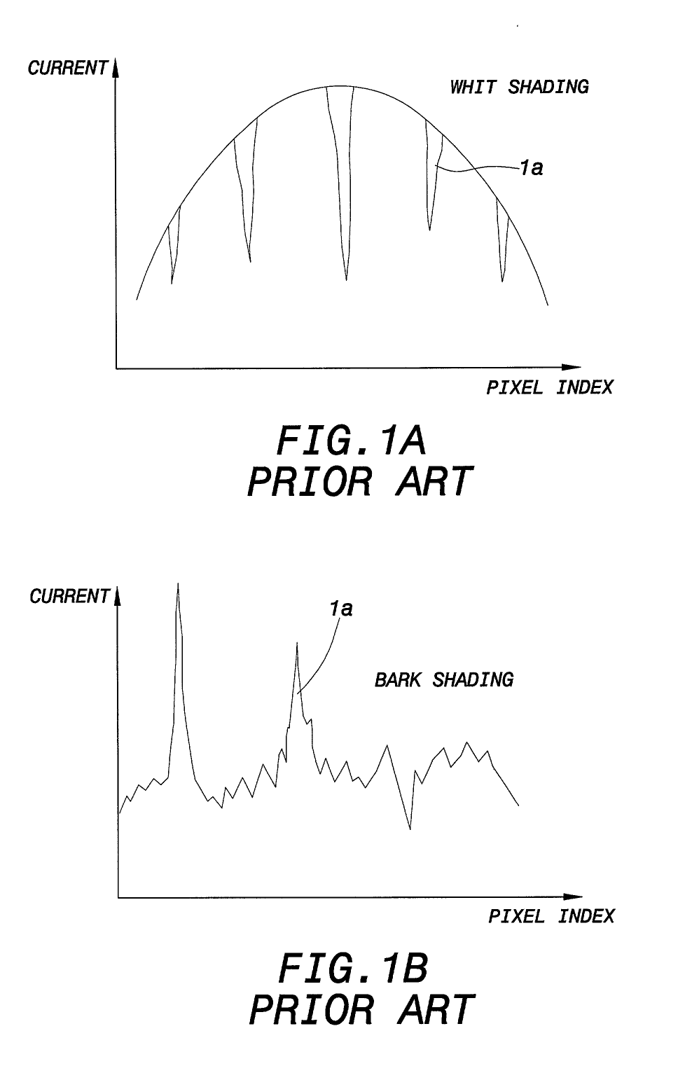

### DETAILED DESCRIPTION OF THE INVENTION

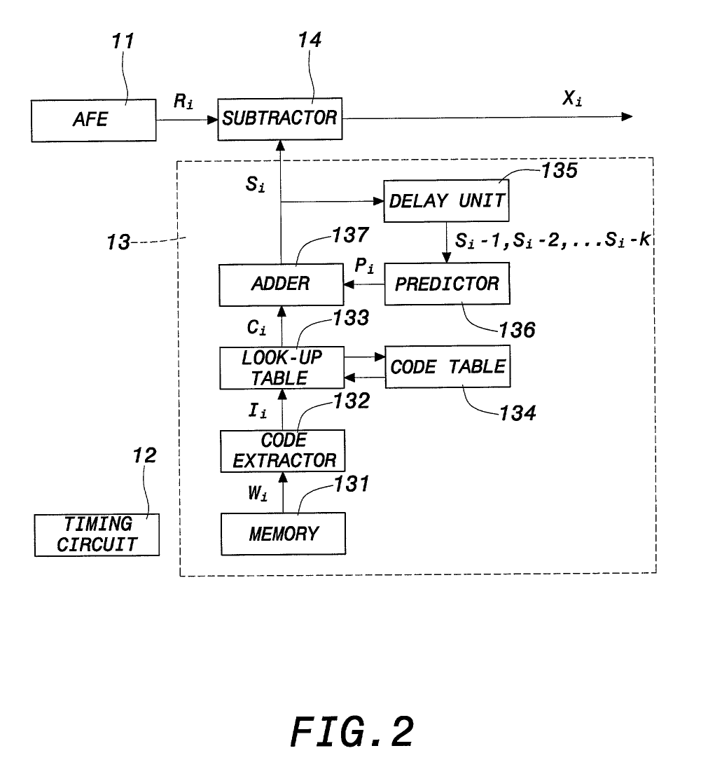

FIG. 2 shows the schematic diagram of the first preferred embodiment of the present invention, which is an offset compensation apparatus for digital image signal. The offset compensation apparatus of the present invention comprises an AFE (analog front end) 11, a timing circuit 12, an offset DPCM unit 13 and a subtractor 14.

The AFE Iᵢ is functioned to digitalize an analog signal from a sensor (not shown) into a digital counter part.

The timing circuit 12 provides timing control for overall system to treat each pixel in the digital image data.

The offset DPCM unit 13 is functioned to obtain offset parameter for each pixel and is composed of a memory 131, a code extractor 132, a look-up table 133, a code table 134, a delay unit 135, a predictor 136 and an adder 137. The memory 131 stores an offset data for each pixel, which is encoded and packeted beforehand in a host platform or offline. The memory 131 is synchronized by the timing circuit 12 and provides an offset codeword Wᵢ for i-th pixel to the code extractor 132. The code extractor 132 generates a code index Iᵢ in response to the offset codeword Wᵢ and sends the code index Iᵢ to the look-up table 133. The look-up table 133 receives the code index Iᵢ and finds a corresponding reconstruction codeword Cᵢ from the code table 134 for the i-th pixel. The delay unit 135 is used to store previous k offset compensation parameters Sᵢ₋₁, Sᵢ₋₂ . . . Sᵢ₋ₖ of the i-th pixel, and the predictor 136 generates a pixel offset prediction Pᵢ=F(Sᵢ₋₁, Sᵢ₋₂ . . . Sᵢ₋ₖ) with reference to the previous k offset compensation parameters Sᵢ₋₁, Sᵢ₋₂ . . . Sᵢ₋ₖ stored in the delay unit 135 and an appropriate prediction function. The adder 137 adds the pixel offset prediction Pᵢ to the reconstruction codeword Cᵢ, thus obtaining an offset compensation parameter Sᵢ for the i-th pixel, i.e., Sᵢ=Pᵢ+Cᵢ.

The subtractor 14 subtract the offset compensation parameter Sᵢ for the i-th pixel from the digital data Rᵢ for the i-th pixel produced by the AFE Iᵢ and generates a compensated image data Xᵢ for the i-th pixel, i.e., Xᵢ=Rᵢ−Sᵢ.

Moreover, the code table 134 contains escape code (not shown) for treating the compensation for the pike noise. If the i-th pixel has pike nose, the prefix of the code index Iᵢ has escape code and the remaining part of the code index Iᵢ points to a reconstruction codeword Cᵢ with more bit to obtain the required offset compensation parameter Sᵢ for the i-th pixel.

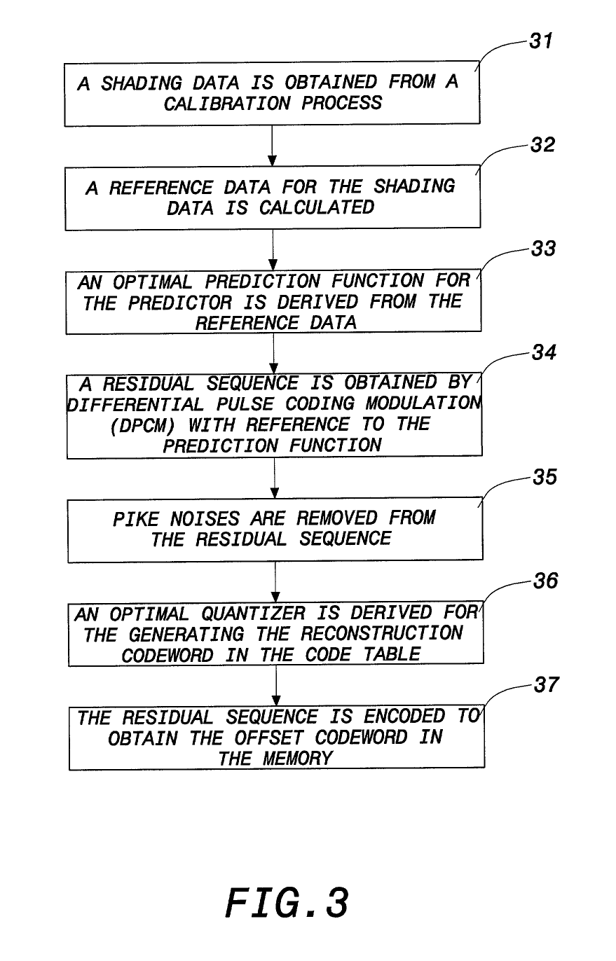

FIG. 3 is a flowchart showing how to obtain the offset codeword Wᵢ in the memory 131, the prediction function used by the predictor 136, and the reconstruction codeword Cᵢ in the code table 134 by a calibration process.

Step 31: A shading data is obtained from a calibration process.

Step 32: A reference data for the shading data is calculated.

Step 33: An optimal prediction function for the predictor 136 is derived from the reference data.

Step 34: A residual sequence is obtained by differential pulse coding modulation (DPCM) with reference to the prediction function.

Step 35: Pike noises are removed from the residual sequence.

Step 36: An optimal quantizer is derived for the generating the reconstruction codeword Cᵢ in the code table 134.

Step 37: The residual sequence is encoded to obtain the offset codeword Wᵢ in the memory 131.

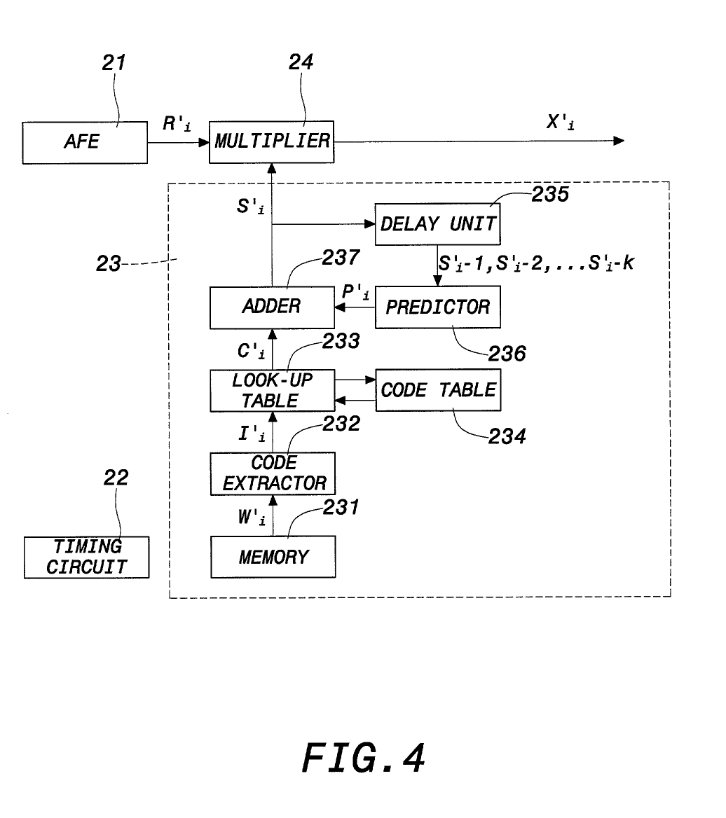

FIG. 4 shows the schematic diagram of the second preferred embodiment of the present invention, which is a gain compensation apparatus for digital image signal. The gain compensation apparatus of the present invention comprises an AFE (analog front end) 21, a timing circuit 22, a DPCM gain unit 23 and a multiplier 24. Similar to the first preferred embodiment of the present invention shows in FIG. 3, the multiplier 24 multiplies the gain compensation parameter S′ᵢ for the i-th pixel to the digital data R′ᵢ for the i-th pixel produced by the AFE 21 and generates a compensated image data X′ᵢ for the i-th pixel, i.e., X′ᵢ=R′ᵢ×S′ᵢ.

The DPCM gain unit 23 has similar components to those in the offset DPCM unit 13 of the first preferred embodiment of the present invention, such as a memory 231, a code table 234 and a predictor 236. Moreover, the generation of offset codeword in the memory 231, the prediction function used by the predictor 236, and the reconstruction codeword in the code table 234 are obtained in similar way to the counterparts in the first preferred embodiment except following:

(a) the size and content of the memory 231;

(b) the way for the code extractor 232 to generate a code index I′ᵢ for i-th pixel;

(c) the size and content of the code table 234;

(d) the length of the delay unit 23;

(e) the prediction function used by the predictor 236.

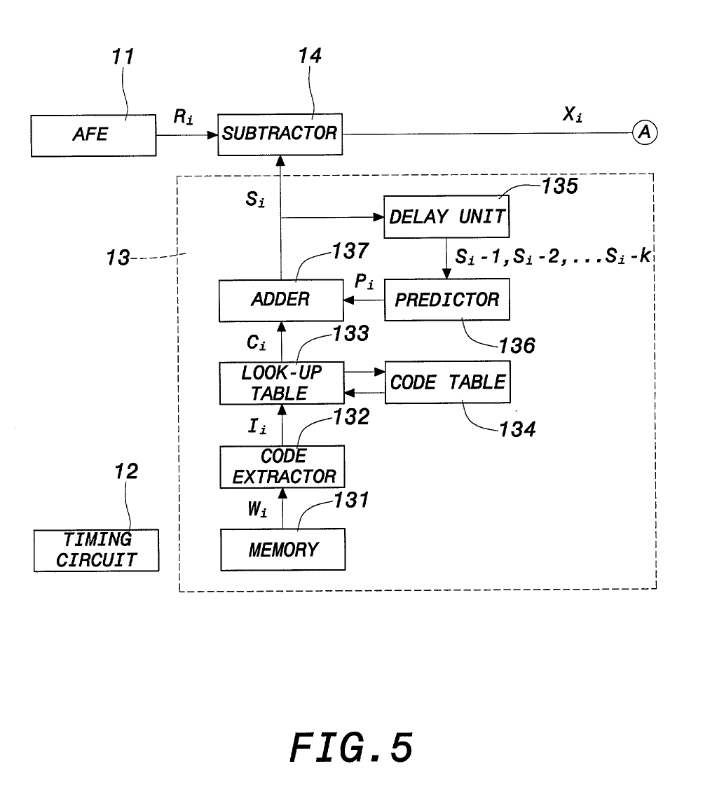

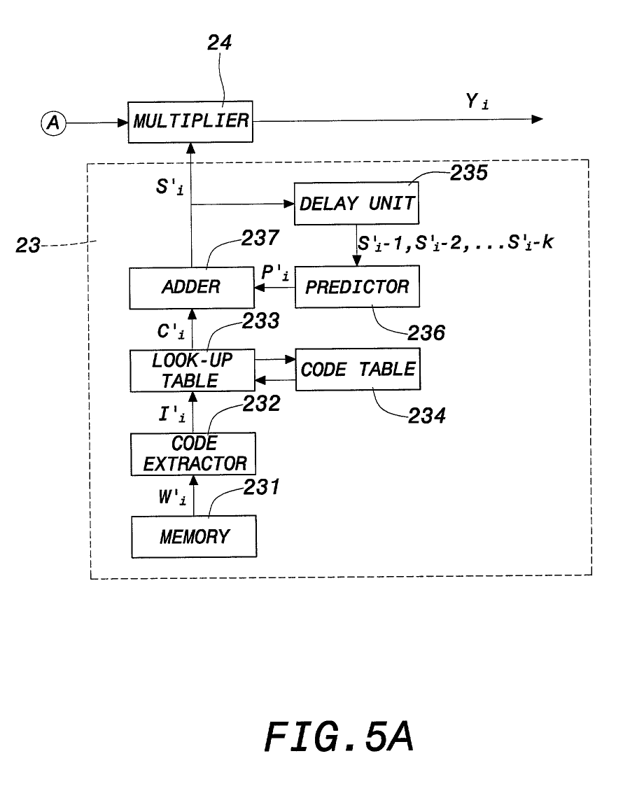

FIGS. 5 and 5A shows the schematic diagram of the third preferred embodiment of the present invention, which is an offset and gain compensation apparatus for digital image signal. The offset and gain compensation apparatus of the present invention comprises an AFE (analog front end) 11, a timing circuit 12, an offset DPCM unit 13, a subtractor 14, a DPCM gain unit 23 and a multiplier 24.

Similar to the first preferred embodiment, the subtractor 14 generates an image data Xᵢ with offset compensation and the multiplier 24 multiplies the image data Xᵢ with offset compensation to gain compensation parameter S′ᵢ to obtain an image data Yᵢ with offset and gain compensation.

For a 1200 dpi A4 size scanned data, the prior art image compensation scheme requires 192 KB DRAM for storing the offset and gain compensation data. The data accessing time is 50 ns if 60 ns DRAM are used. In the present invention, only 38.4 KB DRAM is required if the compression factor of differential pulse coding modulation (DPCM) is 5. In other word, the accessing time is improved to 10 ns in the present invention.

To sum up, the compensation apparatus for digital image signal of the present invention has following advantages:

(1) The storage spaces for the offset and gain compensation data is reduced.

(2) The accessing speed for offset and gain compensation is enhanced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A compensation apparatus for digital image signal, comprising
an AFE (analog front end) functioned to digitalize an analog signal from an image capture apparatus into a digital counterpart, which is composed of a plurality of pixel;
a timing circuit providing timing control for the compensation apparatus;
a differential pulse coding modulation (DPCM) unit for obtaining offset and gain compensation parameter for each pixel; and
an arithmetic unit for performing arithmetic operation to the digital counterpart with respect to the offset and gain compensation parameter of the DPCM unit, thus obtaining compensated pixel.

2. The compensation apparatus for digital image signal as in claim 1, wherein the image capture apparatus is a scanner or a digital still camera (DSC).

3. The compensation apparatus for digital image signal as in claim 1, wherein the DPCM unit is an offset DPCM unit and the arithmetic unit is a subtractor.

4. The compensation apparatus for digital image signal as in claim 3, wherein the offset DPCM unit is composed of
a memory storing an offset data for each pixel, which is encoded and packeted beforehand in a host platform or offline; the memory synchronized by the timing circuit and providing an offset codeword;
a code extractor receiving the offset codeword and generating a code index for each pixel;
a look-up table and a code table, the look-up table receiving the code index and finding a corresponding reconstruction codeword from the code table;
a delay unit and a predictor, the delay unit used to store previous offset compensation parameters with predetermined number, the predictor generating a pixel offset prediction with reference to the previous offset compensation parameters stored in the delay unit; and
an adder adding the pixel offset prediction to the reconstruction codeword, thus obtaining an offset compensation parameter.

5. The compensation apparatus for digital image signal as in claim 4, wherein the code table of the offset DPCM unit can process escape code for treating pike noise.

6. The compensation apparatus for digital image signal as in claim 5, wherein the reconstruction codeword from the code table pointed by an escape code has more bit than other reconstruction codeword.

7. The compensation apparatus for digital image signal as in claim 1, wherein the DPCM unit is a DPCM gain unit and the arithmetic unit is a multiplier.

8. The compensation apparatus for digital image signal as in claim 7, wherein the DPCM gain unit is composed of
a memory storing a gain data for each pixel, which is encoded and packeted beforehand in a host platform or offline; the memory synchronized by the timing circuit and providing a gain codeword;
a code extractor receiving the gain codeword and generating a code index for each pixel;
a look-up table and a code table, the look-up table receiving the code index and finding a corresponding reconstruction codeword from the code table;
a delay unit and a predictor, the delay unit used to store previous gain compensation parameters with predetermined number, the predictor generating a pixel offset prediction with reference to the previous gain compensation parameters stored in the delay unit; and
an adder adding the pixel gain prediction to the reconstruction codeword, thus obtaining the gain compensation parameter.

9. The compensation apparatus for digital image signal as in claim 8, wherein the code table of the DPCM gain unit can process escape code for treating pike noise.

10. The compensation apparatus for digital image signal as in claim 9, wherein the reconstruction codeword from the code table pointed by an escape code has more bit than other reconstruction codeword.

11. A compensation apparatus for digital image signal, comprising
an AFE (analog front end) functioned to digitalize an analog signal from an image capture apparatus into a digital counterpart, which is composed of a plurality of pixel;
a timing circuit providing timing control for the compensation apparatus;
an offset DPCM unit for obtaining offset compensation parameter for each pixel;
a subtractor subtracting the offset compensation parameter of the offset DPCM unit from the digital counterpart and obtaining an image data with offset compensation;
a DPCM gain unit for obtaining gain compensation parameter for each pixel; and
a multiplier multiplying the gain compensation parameter of the DPCM gain unit to the an image data with offset compensation, thus obtaining an image data with offset and gain compensation.

12. The compensation apparatus for digital image signal as in claim 11, wherein the image capture apparatus is a scanner or a digital still camera (DSC).

13. The compensation apparatus for digital image signal as in claim 11, wherein the offset DPCM unit is composed of
a memory storing an offset data for each pixel, which is encoded and packeted beforehand in a host platform or offline; the memory synchronized by the timing circuit and providing an offset codeword;
a code extractor receiving the offset codeword and generating a code index for each pixel;
a look-up table and a code table, the look-up table receiving the code index and finding a corresponding reconstruction codeword from the code table;
a delay unit and a predictor, the delay unit used to store previous offset compensation parameters with predetermined number, the predictor generating a pixel offset prediction with reference to the previous offset compensation parameters stored in the delay unit; and
an adder adding the pixel offset prediction to the reconstruction codeword, thus obtaining an offset compensation parameter. 13. The compensation apparatus for digital image signal as in claim 12, wherein the code table of the offset and DPCM gain unit can process escape code for treating pike noise.

14. The compensation apparatus for digital image signal as in claim 13, wherein the code table of the offset DPCM unit can process escape code for treating pike noise.

15. The compensation apparatus for digital image signal as in claim 14, wherein the reconstruction codeword from the code table pointed by an escape code has more bit than other reconstruction codeword.

16. The compensation apparatus for digital image signal as in claim 11, wherein the DPCM gain unit is composed of
a memory storing a gain data for each pixel, which is encoded and packeted beforehand in a host platform or offline; the memory synchronized by the timing circuit and providing a gain codeword;
a code extractor receiving the gain codeword and generating a code index for each pixel;
a look-up table and a code table, the look-up table receiving the code index and finding a corresponding reconstruction codeword from the code table;
a delay unit and a predictor, the delay unit used to store previous gain compensation parameters with predetermined number, the predictor generating a pixel offset prediction with reference to the previous gain compensation parameters stored in the delay unit; and
an adder adding the pixel gain prediction to the reconstruction codeword, thus obtaining the gain compensation parameter.

17. The compensation apparatus for digital image signal as in claim 16, wherein the code table of the DPCM gain unit can process escape code for treating pike noise.

18. The compensation apparatus for digital image signal as in claim 17, wherein the reconstruction codeword from the code table pointed by an escape code has more bit than other reconstruction codeword.
